(19) United States
(12) Patent Application Publication
(10) Pub. No.: US 2019/0303514 A1
(43) Pub. Date: Oct. 3, 2019

(54) FEATURE-BASED MERGING FOR MULTI-USER CAX

(71) Applicant: United Technologies Corporation, Farmington, CT (US)

(72) Inventor: Joshua Daniel Winn, Ellington, CT (US)

(21) Appl. No.: 15/942,647

(22) Filed: Apr. 2, 2018

(51) Int. Cl. G06F 17/50; G06F 17/30

(52) U.S. Cl. CPC G06F 17/5009; G06F 17/30946

(57) ABSTRACT

A system for collaborating on a component according to an example of the present disclosure includes, among other things, a computing device that has a processor and a memory storage device. The processor is configured to execute a first multi-user computer-aided technologies (CAx) environment that has a data module and a comparison module. The data module is configured to access at least one database corresponding to a component design. The component design has a plurality of features each corresponding to a group of feature types, and each of the plurality of features establishes a respective spatial boundary. The comparison module is configured to cause a first feature and a second feature of the plurality of features to merge into a resultant feature of the component design in response to determining that the spatial boundary of the first feature and the spatial boundary of the second feature share a common interface.

### BACKGROUND

This disclosure relates to computer-aided technologies (CAx), and more particularly, to merging features of component designs in a computing environment.

CAx software is used to develop tools, parts, assemblies, structures and other components using a computer system during the design, analysis, and manufacturing phases, for example. CAx software may be used by a user or group of users to build, analyze, and manufacture complex elements. CAx software is typically restricted to a single user paradigm, wherein only a single user can edit a model or part file within a CAx software application at a time. The user must exit the file before another user is allowed to access it.

### SUMMARY

A system for collaborating on a component according to an example of the present disclosure includes a computing device that has a processor and a memory storage device. The processor is configured to execute a first multi-user computer-aided technologies (CAx) environment that has a data module and a comparison module. The data module is configured to access at least one database corresponding to a component design. The component design has a plurality of features each corresponding to a group of feature types, and each of the plurality of features establishes a respective spatial boundary. The comparison module is configured to cause a first feature and a second feature of the plurality of features to merge into a resultant feature of the component design in response to determining that the spatial boundary of the first feature and the spatial boundary of the second feature share a common interface.

In a further embodiment of any of the foregoing embodiments, the first feature is a first sketch, and the second feature is a second, different sketch.

In a further embodiment of any of the foregoing embodiments, the first sketch includes a first set of features, and the second sketch includes a second, different set of features.

In a further embodiment of any of the foregoing embodiments, the first set of features includes a first geometric feature, the second set of features includes a second geometric feature, and the first geometric feature and the second geometric feature are defined along the common interface.

In a further embodiment of any of the foregoing embodiments, the first sketch is associated with the first multi-user CAx environment, and the second sketch is associated with a second multi-user CAx environment.

In a further embodiment of any of the foregoing embodiments, the comparison module causes the data module to store data corresponding to the component design in the at least one database such that first and second features are replaced with the resultant feature.

In a further embodiment of any of the foregoing embodiments, constraints of the resultant feature are based on constraints of the first feature and constraints of the second feature.

In a further embodiment of any of the foregoing embodiments, the resultant feature excludes at least one constraint defining the common interface.

In a further embodiment of any of the foregoing embodiments, the constraints of the first feature and the constraints of the second feature define respective end points along the common interface.

In a further embodiment of any of the foregoing embodiments, geometry of the resultant feature is at least one of point continuous, tangent continuous and curvature continuous relative to at least one of the respective end points.

In a further embodiment of any of the foregoing embodiments, the common interface is defined such that geometry corresponding to the constraints of the first feature overlaps with geometry corresponding to the constraints of the second feature along the common interface.

In a further embodiment of any of the foregoing embodiments, the common interface is defined such that geometry corresponding to the constraints of the first feature is identical to geometry corresponding to the constraints of the second feature along the common interface.

A system for collaborating on a component according to an example of the present disclosure includes a first client multi-user computer-aided technologies (CAx) environment and a second client multi-user CAx environment each that has a data module and a display module. The data module is configured to access at least one database corresponding to a component design. The component design has a plurality of features each correspond to a group of feature types, and the display module is configured to display data corresponding to the component design during a multi-user CAx session established between the first client multi-user CAx environment and the second client multi-user CAx environment. A host server has a processor and a memory storage device. The processor is configured to execute a host multi-user CAx environment that has a synchronization module, and the memory storage device is configured to store the at least one database accessible by the host multi-user CAx environment. The plurality of features has a first sketch and a second sketch. The first sketch is associated with the first client multi-user CAx environment. The second sketch associated with the second client multi-user CAx environment, and each of the first and second sketches establishes a respective spatial boundary. The synchronization module is configured to cause features of the first sketch and features of the second sketch to merge into a resultant sketch of the component design in response to determining that the spatial boundary of the first sketch and the spatial boundary of the second sketch share a common interface.

In a further embodiment of any of the foregoing embodiments, the synchronization module is configured to cause at least some features of the first and second sketches along the common interface to be eliminated in the at least one database in response to determining that the at least some features extend along the common interface.

A method for collaborating on a component according to an example of the present disclosure includes the steps of generating a first sketch of a component design by a first multi-user computer-aided technologies (CAx) environment, and generating a second sketch of the component design by a second multi-user CAx environment. The component design includes a plurality of features that correspond to a group of feature types defined by a multi-user CAx command set executable by the first multi-user CAx environment and the second multi-user CAx environment. The plurality of features have a first set of geometric features associated with the first multi-user CAx environment and a second set of geometric features associated with the second multi-user CAx environment. Each of the first and second sketches establishes a respective spatial boundary. The method includes the step of causing the first sketch and the second sketch to merge into a resultant sketch of the component design in response to determining that the spatial boundary of the first sketch and the spatial boundary of the second sketch share a common interface.

In a further embodiment of any of the foregoing embodiments, the step of determining that the spatial boundary of the first sketch and the spatial boundary of the second sketch share the common interface includes determining that geometry corresponding to constraints of the first sketch that define the common interface overlaps with geometry corresponding to constraints of the second sketch along the common interface.

A further embodiment of any of the foregoing embodiments includes storing at least one of the first sketch and the second sketch in a database corresponding to the component design prior to the step of causing the first sketch and the second sketch to merge, and storing the resultant sketch in the database.

In a further embodiment of any of the foregoing embodiments, geometric features of the first and second sketches are defined along the common interface. The step of causing the first sketch and the second sketch to merge includes causing at least some of the geometric features to be eliminated in the database.

In a further embodiment of any of the foregoing embodiments, the step of causing the first sketch and the second sketch to merge includes causing geometry of the resultant sketch to be at least one of point continuous, tangent continuous and curvature continuous relative to an end point of at least one of the geometric features along the common interface.

A further embodiment of any of the foregoing embodiments includes accessing the first sketch and the second sketch from the database by the first multi-user CAx environment, displaying the component design in the first multi-user CAx environment according to the first sketch and the second sketch prior to the step of causing the first sketch and the second sketch to merge, and displaying the component design in the first multi-user CAx environment according to the resultant sketch, but not according to the first sketch and the second sketch, subsequent to the step of causing the first sketch and the second sketch to merge.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates a system for a multi-user CAx environment, according to an embodiment.

FIG. 2A illustrates a sample component design displayed in a first CAx environment, according to an embodiment.

FIG. 2B illustrates the sample component design of FIG. 2A displayed in a second CAx environment, according to an embodiment.

FIG. 2C illustrates a plan view of a portion of the sample component design of FIG. 2A including two sketches, according to an embodiment.

FIG. 3 illustrates a system for merging aspects of a component design, according to an embodiment.

FIG. 4 illustrates a plan view of a portion of a sample component design including a resultant sketch, according to an embodiment.

FIG. 5 illustrates a process for merging aspects of a component design, according to an embodiment.

### DETAILED DESCRIPTION

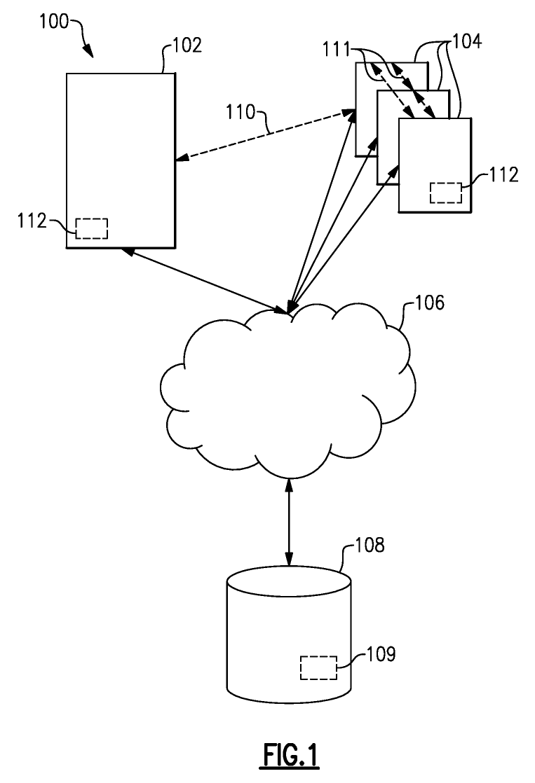

FIG. 1 illustrates a computing architecture or system 100 for executing a multi-user CAx environment, according to an embodiment. The system 100 includes a host server or computer 102. The host computer 102 may include one or more of a computer processor, memory, storage means, network device, and input and/or output devices and/or interfaces. The host computer 102 is configured to execute one or more software programs. In one embodiment, the host computer 102 is more than one computer jointly configured to process software instructions serially or in parallel.

In some embodiments, the host computer 102 is in communication with one or more networks such as a network 106 comprised of one or more computing devices. The system 100 additionally includes one or more client computers 104. The host computer 102 and the one or more client computers 104 typically include one or more of a computer processor, memory, storage means, network device and input and/or output devices and/or interfaces according to some embodiments. The memory may, for example, include UVPROM, EEPROM, FLASH, RAM, ROM, DVD, CD, a hard drive, or other computer readable medium which may store data and/or the CAx software of this description. The host computer 102 and the one or more client computers 104 may be a desktop computer, laptop computer, smart phone, tablet, or any other computer device. In some embodiments, one or more of the host computer 102 and the one or more client computers 104 include an input device, such as a keyboard and mouse, and one or more output devices such as a monitor, speakers, printers, etc. The interface facilitates communication with the other systems and/or components of the network 106.

In some embodiments of collaboration between multiple CAx users, each of the client computers 104 is a user workstation capable of accessing and locally running CAx software and providing a CAx environment 112. In some embodiments, the CAx environment 112 is operable to perform one or more CAx functions including at least one CAx tool, including a computer-aided design (CAD), computer-aided engineering (CAE) and/or computer-aided manufacturing (CAM) tool, for example. In other embodiments, at least one of the client computers 104 is operable to execute different CAx functions. In some embodiments, the CAx environment 112 provides a display or visualization of a component design stored one or more part files, according to one or more visualization settings, and can be provided via one or more graphical user interfaces (GUI).

In some embodiments, the one or more client computers 104 are configured to communicate with the host computer 102 directly via a direct client interface 110 or over the network 106. The one or more client computers 104 are configured to execute one or more software programs, such as a CAx package. In some embodiments, the CAx package is configured to communicate with the host computer 102 either over the network 106 or directly through the direct client interface 110. In another embodiment, the one or more client computers 104 are configured to communicate with each other directly via a peer-to-peer interface 111.

The network 106 may be a private local area network (LAN), a private wide area network (WAN), the Internet, a mesh network, or any other network as is known in the art. The system 100 additionally includes at least one storage system 108, which in some embodiments is operable to store or otherwise provide data to other computing devices. In one embodiment, the storage system 108 is a storage area network device (SAN) configured to communicate with the host computer 102 and/or the one or more client computers 104 over the network 106. In another embodiment, the storage system 108 is located within the host computer 102 or within at least one of the client computers 104. The storage system 108 may be configured to store one or more of computer software instructions, data, CAx files, database files, configuration information, etc.

In some embodiments, the system 100 is a client-server architecture configured to execute computer software on the host computer 102, which is accessible by the one or more client computers 104 using either a thin client application or a web browser executing on the one or more client computers 104. In some embodiments, the host computer 102 loads the computer software instructions from local storage, or from the storage system 108, into memory and executes the computer software using the one or more computer processors.

In some embodiments of the multi-user CAx architecture, each part file is stored within a database 109 at a central location, for instance at storage system 108. In another embodiment, the database 109 is stored at host computer 102 or is a distributed database provided by one or more of the client computers 104. In some embodiments, the database 109 is a relational database, and each part file in the database 109 is associated with a sub-assembly or assembly. In other embodiments, each feature, feature type, part, component design, sub-assembly and assembly corresponds to a unique identifier or database entry. In some embodiments, the database 109 is linked or otherwise corresponds to multiple part files. In an embodiment, the database 109 is configured to store data corresponding the component design one or more database records or entries, rather than linking or otherwise associating one or more part files to the database 109.

Each part file comprises one or more features, each feature corresponding to one or more feature types discussed below. In some embodiments, the part file includes a part tree or another data structure to organize and associate the features in a parent-child relationship between different features and/or part files. Each feature can be applied to one or more base features which together comprise the component design. Although the teachings of this disclosure refer primarily to featured-based CAx tools or systems, it should be appreciated that other CAx tools, systems or environments can benefit from the teachings herein, including geometrical-based CAD models.

The term “feature type” is defined as a geometric or non-geometric operation, or a result of such operation, available in a CAx tool to characterize a component design. The various feature types can be stored in one or more software libraries as one or more data classes which can be instantiated by the CAx tool.

The term “feature” refers to an instance of a feature type, which can include one or more software commands, or a result of its operation (such as a geometric object). Each feature is represented by a data set and has one or more parameters or attributes, such as a unique feature identifier, a feature type, spatial position and orientation, body type such as a wireframe or solid, and/or its hierarchical relation to other features in a part tree, for example.

Some geometric feature types include two-dimensional sketches comprised of one or more one-dimensional geometries, such as points, lines or curves, and two-dimensional geometries such as rectangles or ellipses. A sketch, in some instances, provides a rough approximation of the desired dimensioning of the various aspects of a component design. In yet other embodiments, the feature types include various operations to create or modify solid(s) or other three-dimensional geometry such as wireframes, from one or two dimensional features. These various feature types include extrude(s), revolve(s), loft(s), sweep(s), chamfer(s), boundaries, and meshes, for example. The feature types can include operations such as a Boolean operation to add or subtract one feature from another feature, a mirror or a pattern operation to replicate at least one other feature, and an edge blend operation.

Various non-geometric feature types are contemplated including datum such as point(s), plane(s), axes, and coordinate system(s) utilized to arrange or orient other features, and in some instances may not comprise a final design of the component. Other non-geometric feature types can be used to further characterize a base feature comprising a component design, such as surface shading and coloring, material composition and dimensions. Of course, many other feature types utilized to create and further define the various aspects of a component design are contemplated within the teachings of this disclosure.

These various feature types and corresponding features typically have different levels of relevance to various disciplines involved in the collaboration of a component design. Each feature type and feature can also have different levels of applicability with respect to artifacts of the design process, including two-dimensional drawings such as schematics, engineering drawings or blueprints, wireframe models, surface models, and solid models, and also as inputs to other CAx tools such as finite element analysis (FEA) and computational fluid dynamics (CFD) models.

In some embodiments, the CAx environment 112 is configured to designate one or more features or feature types as a layer. Example layers include sketches, wireframes and solids, which in some embodiments are provided by the CAx software as default layer(s). In other embodiments, a user manually selects feature(s) and/or feature type(s) to be associated with at least one layer. In some embodiments, each layer is defined at system initialization, and in other embodiments, each layer is defined during operation. Each layer is utilized to filter the selected features or feature types in a part file loaded into the CAx environment.

Multiple users each provided with a CAx environment 112 via the client computers 104 are able to simultaneously access each part file stored in the database 109 and are able to view and modify various aspects of a component design corresponding to one or more part files. In some embodiments, the part file is stored locally at the storage system 108, with local copies of the part file at the client computers 104 being synchronized periodically. Modifications to each part file are communicated to each CAx environment 112 currently accessing the part file, either in real-time or periodically utilizing a synchronization scheme. Display or visualization of the modification is therefore made substantially immediately available in CAx environments 112 accessing the same part file, which can assist the multiple users in reducing, identifying/or and resolving conflicts or inconsistencies in various aspects of a component design, thereby ensuring that a particular design intent is met.

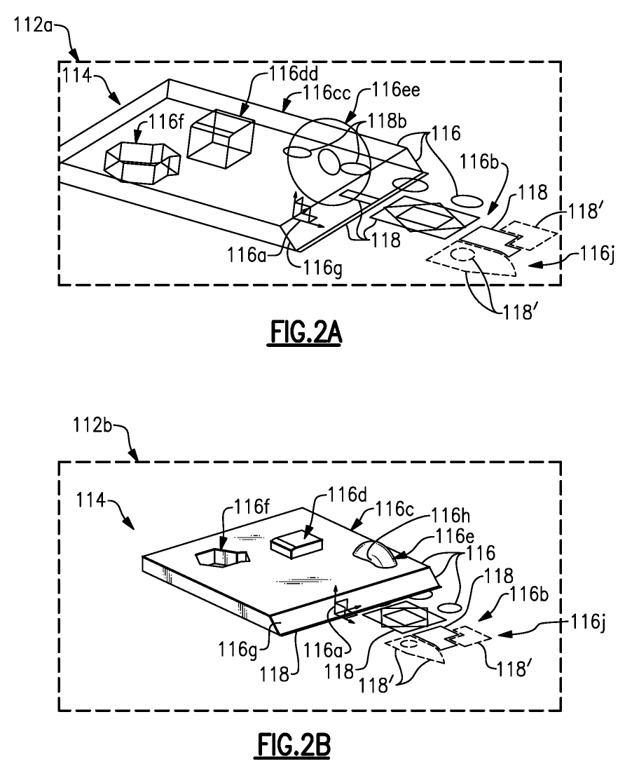

FIGS. 2A-2B illustrate an embodiment in which two users collaborate on various aspects of a component design 114. In this embodiment, a first user is provided with a first multi-user CAx environment 112a, and a second user is provided with a second multi-user CAx environment 112b, shown in FIGS. 2A-2B respectively. Each of the CAx environments 112a, 112b can be client multi-user CAx environments associated with a different one of the client computers 104, for example.

The example component design 114 includes one or more features 116 each corresponding to a feature type, according to some embodiments. The features 116 shown in FIG. 2A include a datum coordinate system 116a, and a sketch 116b having one or more sketch entities or geometric features 118 illustrated as ellipses and rectangles, for example. Some features 116 shown in FIG. 2B include solids such as extrudes 116c, 116d, which are applied to geometric features 118 of the sketch 116b and are characterized by wireframes 116cc, 116dd shown in FIG. 2A. Other example features include a hole or Boolean 116f forming an opening in the extrude 116c, and a chamfer 116g applied to extrude 116c. Non-geometric features include surface shading 116h (shown in FIG. 2B) applied to the rotate 116e feature. Each geometric feature 118 can be one of the features 116, or can be a sub-feature of the respective feature 116.

Each of the multiple users is able to select one or more visualization settings to characterize the display of the component design 114 in a viewing frustum provided by a CAx environment 112 based on a particular situation, as illustrated in FIGS. 2A-2B. For the purposes of this disclosure, the term “visualization setting” means data corresponding to one or more features, feature types, layers or other parameters which can be utilized to display a component design 114 in a CAx environment 112. The term “viewing frustum” refers to a region of modeling space in a window of the CAx environment 112 modeling the component design 114 that characterizes the display of a model or component design 114, in a graphical user interface (GUI) for example. The viewing frustum is characterized by the spatial position and/or orientation of the component design 114 in the modeling space. The CAx environment 112 displays selected portions of the component design 114 stored in one or more part files based on these visualization setting(s). Accordingly, modifications or updates made by other user(s) to the component design may not be displayed in the CAx environment 112.

FIGS. 2A and 2B illustrate different visualization settings for CAx environments 112a, 112b, according to an embodiment. As illustrated by the CAx environment 112a in FIG. 2A, the user has selected one or more visualization settings to show the wireframe geometries 116cc, 116dd, 116ee and to hide the corresponding solid features 116c, 116d, 116e. In the CAx environment 112b shown in FIG. 2B, the user has selected one or more visualization settings to show solid features 116c, 116d, 116e and to hide wireframes 116c, 116d, 116f, for example. The visualization settings of each CAx environment 112 can be customized according to the needs of a particular situation even though each of the users is working on the same component design 114.

In some situations, the multiple users who use a CAx environment 112 are assigned with creating and/or modifying different portions of a component design. For example, responsibility between a team of users can be divided or allocated to allow the users to work simultaneously using the multi-user CAx system. Work can be divided such that a first user provided with the first multi-user CAx environment 112a can be assigned with creating a first sketch corresponding to a first portion of a gas turbine engine assembly or cross-section, such as a rotor, and a second user provided with the second multi-user CAx environment 112b can be assigned with creating a second sketch corresponding to a second portion of the gas turbine engine assembly, such as a plurality of rotatable blades carried by the rotor. The respective first and second sketches can be worked simultaneously by the first and second users. Other portions of the assembly can be divided into additional sketches and assigned to one or more users provided with a CAx environment 112.

The first and second sketches can have common interfaces that are “line-on-line” or share a common spatial location. When the component design is completed, the component design can have duplicate entries at a single data point. The component design can also have discrete edges between the resulting three-dimensional geometry of the component design due to the sketch division. This can cause potential meshing issues when exporting the component design to a CAx software package. Also, manually editing geometry or merging features of the component design to eliminate the discrete edges between the sketches can be time intensive. Accordingly, it may be desirable to identify and merge features of the component design that share a common interface.

For example, the component design 114 can include another sketch 116j also having one or more sketch entities or geometric features 118′ (shown in dashed lines) illustrated as ellipses and complex geometry defined by curves and line segments. Sketch 116b can be generated or otherwise associated with the first CAx environment 112a, and sketch 116j can be generated or otherwise associated with the second CAx environment 112b, for example. A first user profile associated with the first CAx environment 112a may be assigned with the responsibility of creating, modifying or generating aspects of sketch 116b, and a second user profile associated with the second CAx environment 112b may be assigned with the responsibility of creating, modifying or generating aspects of sketch 116j.

FIG. 2C illustrates a plan view of a portion of the component design 114 including portions of the sketches 116b and 116j that comprise a plurality of features 116, 116′ including geometric features 118, 118′ of the component design 114. Each of the sketches 116b, 116j includes different sets of geometric features 118, 118′ that establish a respective spatial boundary BR. For the purposes of this disclosure, the term “spatial boundary” means the outermost edge(s) of the respective sketch or feature.

The spatial boundary BR can be an overall boundary established by a group of features, such a perimeter of a group of features 118, 118′ that define the respective sketch 116b, 116j, or for each individual feature 118, 118′. In the illustrated embodiment of FIG. 2C, three spatial boundaries BR₁, BR₂, BR₃ and BR₄ are established by the respective geometric features 118, 118′, with boundary BR₁ defining a portion of the boundary BR of sketch 116b, and with boundaries BR₂, BR₃ and BR₄ defining the boundary BR of sketch 116j.

In the illustrated embodiment of FIG. 2C, at least some of the spatial boundaries BR₁, BR₂, BR₃ and BR₄ share or establish a common interface CC, including common interfaces CC₁-CC₄. For the purposes of this disclosure, the term “common interface” means a location in which two or more spatial boundaries are geometrically defined along the same physical space of the component design 114. Common interface CC₁ is established between points P₁, P₂ and extends through point P₃. Common interface CC₂ is established between points P₄, P₅. Common interface CC₃ is established between points P₅, P₆. Common interface CC₄ is established between points P6, P₇. The geometrical features 118, 118′ along the common interfaces CC₁-CC₄ are line-on-line in the illustrated example of FIG. 2C.

Common interface CC₁ includes a component defined between point P₁, P₃ that is defined by line segments of the features 118, 118′. Common interface CC₁ also includes a component defined between point P₂, P₃ that is defined by arc segments of the features 118, 118′. It should be appreciated that the geometry of FIGS. 2A-2C is disclosed for illustrative purposes, and the teachings herein can be utilized with other geometries and features.

As previously discussed, the discrete edges of the features 118, 118′ along the common interfaces CC can result in potential meshing issues when exporting the component design 114 to a CAx software package. Accordingly, it may be desirable to identify and merge features of the component design that share a common interface.

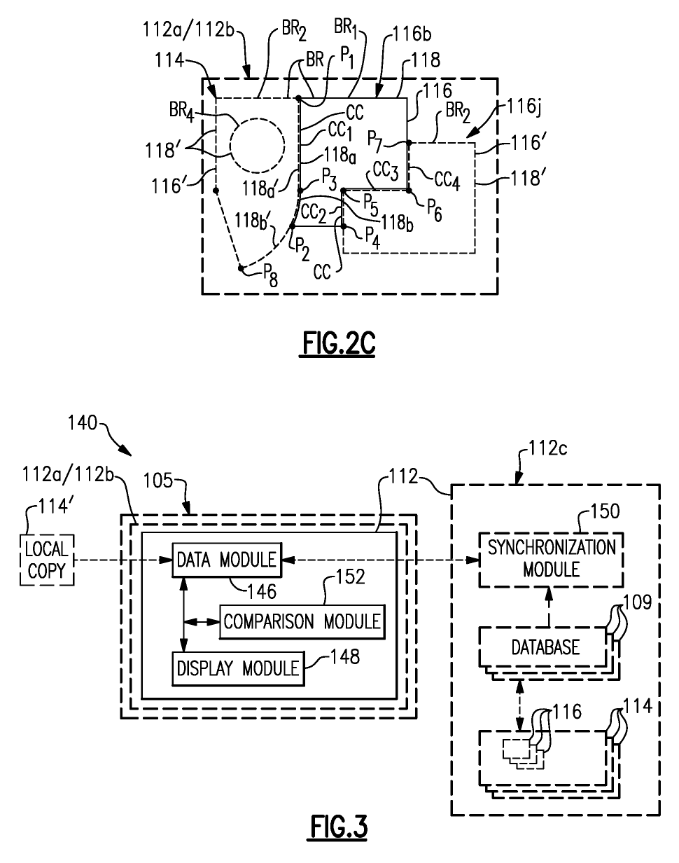

FIG. 3 illustrates a CAx package 140 for collaborating on a component design 114 with another CAx environment, such as one of the CAx environments 112a, 112b, according to an embodiment. The CAx package 140 is operable to merge features of component designs in a computing environment, including two or more features having spatial boundaries that extend along a common interface. The features can be merged into a format supported by a local application programming interface (API) of the client computer 104 or at the application level of the CAx package 140. The CAx package 140 is configured to store data corresponding to a component design 114, including features 116, 118 and/or feature types corresponding to the component design 114.

In the illustrated embodiment of FIG. 3, the CAx package 140 is provided as a portion of a CAx software tool integrated into or with a CAx environment 112. In other embodiments, the CAx package 140 is a standalone software program and is configured to interface with a CAx software tool to provide the desired solution. The CAx package 140 can be provided by a tangible or non-transitory computer-readable storage medium and installed at one or more computing devices 105, such as one of the computers 102, 104 of FIG. 1, for example. The computing device 105 includes a processor and a memory storage device, and the processor is configured to execute the CAx environment 112. The CAx package 140 includes one or more modules operable to store data corresponding to the component design 114. Each of these modules includes executable software instructions and/or digital or analog hardware circuitry.

The CAx package 140 can include a data module 146 in communication with a display module 148 and a comparison module 152. The data module 146 is configured to access, retrieve and/or store data corresponding to a component design 114, including data corresponding to the respective features 116, 118. In some embodiments, the data module 146 is configured to access and store data corresponding to the component design 114 in one or more databases 109 as one or more tables, records or entries. In embodiments, the data is stored in one or more part files and is accessible by referencing one or more objects or memory locations references by the records or entries. The data module 146 can be configured to access and store the data to a local copy 114′ of the component design 114 that can be stored in local memory.

The display module 148 is configured to display data corresponding to the component design 114 in the CAx environment 112, such as in one of the CAx environments 112a, 112b. In embodiments, the data module 146 is configured to create the local copy 114′, which is updated or synchronized in real-time or periodically as modifications to the component design 114 occur, and in some embodiments is displayed in response to modification of the component design 114. The display module 148 can be configured to display data corresponding to the local copy 114′. In embodiments, data corresponding to one or more features 116 of the component design 114 is stored remotely from a computing platform storing the local copy 114′, such as one of the databases 109. The display module 148 is configured to display data corresponding to the component design 114 during a multi-user CAx session established between two or more client and/or host multi-user CAx environments 112, such as the multi-user CAx environments 112a, 112b.

The comparison module 152 is configured to cause the data module 146 to store data corresponding to the component design 114 to a particular location, such as the database(s) 109, local copy 114′ and/or part file(s). The comparison module 152 is configured to cause two or more features 116, 118 of the component design 114 to be wrapped or merge into resultant feature(s) of the component design 114 in response to determining that the respective spatial boundaries of the features 116, 118 share a common interface CC.

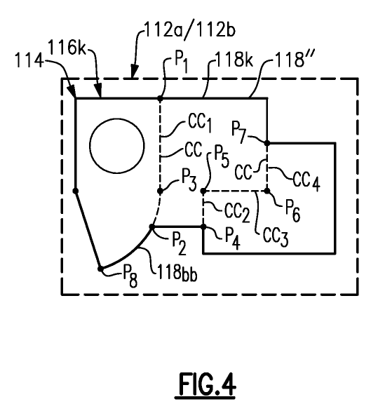

Referring to FIGS. 2C and 4, with continued reference to FIG. 3, two or more features 116, 116′ of the component design 114 can be merged along at least one of the common interfaces CC₁-CC₄. The comparison module 152 can be programmed to merge the features 116, 116′ along the common interfaces CC₁-CC₄ automatically, or manually in response to user interaction by a user provided with the functionality of the CAx package 140 and selection of the desired features 116, 116′ to merge, such as by interacting with one or more graphical user interfaces (GUI).

For example, the comparison module 152 can cause two or more geometric features 118, 118′ of the sketches 116b, 116j to merge into a resultant sketch 116k (FIG. 4) in response to determining that the geometric features 118, 118′ establish or otherwise share one of the common interfaces CC₁-CC₄.

In the illustrated embodiment of FIG. 2C, sketch 116b can include a first set of geometric features 118 including geometric features 118a, 118b, and sketch 116j can include a second set of features 118′ including geometric features 118a′, 118b′. The geometric features 118a, 118a′ are line segments defined along the common interface CC₁, with each line segment having end points at points P₁ and P₃ such that the features 118a, 118a′ are geometrically identical. The geometric features 118b, 118b′ are arc segments defined along the common interface CC₁, with geometric feature 118b being an arc segment having end points at points P₂ and P₃ and with geometric feature 118b′ being an arc segment having end points at points P₃ and P₈.

The comparison module 152 is programmed with logic to determine that the geometric features 118a, 118a′ are defined along the common interface CC₁, and with logic to determine that the geometric features 118b, 118b′ are also defined along the common interface CC₁. The logic can include comparing coordinate sets of the geometric features 118, 118′ to each other, and determining that coordinate(s) of the respective coordinate sets or respective constraints are geometrically identical or otherwise overlap.

The logic can include comparing coordinate sets of the geometric features 118b, 118b′ to each other, and determining that the respective coordinate sets are identical or are substantially identical. For example, the respective coordinate sets of the geometric features 118b, 118b′ can define respective splines. The respective splines may closely overlap each other but may not be identical due to approximations of the respective arc geometry.

The comparison module 152 can be programmed with logic to determine that the respective coordinate sets of the geometric features 118b, 118b′ closely overlap with respect to a predefined tolerance. The predefined tolerance may correspond to a tolerance set for the component design 114 or can be set by the user for querying by the comparison module 152, for example. Example predefined tolerances can include approximately ±1% or ±3% of a length of the respective common interface CC, for example. The logic can include comparing a distance between adjacent points in the respective coordinate sets and determining that the respective distance does not exceed the predefined tolerance.

The comparison module 152 is configured to cause the data module 146 to store data corresponding to the component design 114 in the database(s) 109 such that the respective geometric features 118, 118′ of the sketches 116b, 116j are replaced with resultant feature(s) of the resultant sketch 116k. For example, the arc segments of geometric features 118b, 118b′ can be replaced in the component design 114 with a resultant geometric feature 118bb that is an arc segment between points P₂ and P₈ (FIG. 4).

Each of the features 116/118 can be expressed as one or more constraints. For the purposes of this disclosure, the term “constraint” means a feature of a CAx system that defines a scalar (i.e., length or magnitude) or direction applied to an origin or starting point to define a respective geometrical entity. Constraints can be applied to define lines, arcs and splines, for example. Constraints of a line can be expressed by a length, direction and end points. Constraints can be applied to multiple features, such as a tangent of a curve to a line segment, or a length of one feature being equal to a length of another feature. Geometry of the resultant feature can be at least one of point continuous (C0), tangent continuous (C1) and curvature continuous (C2) relative to at least one of the respective end points of the features that are merged. The term “point continuous” refers to two line segments that extend from a common end point. The term “tangent continuous” refers to an arc segment extends from an end of a line segment such that the line segment is tangential to the arc segment. The term “curvature continuous” refers to arc segments that are defined by the same radius of curvature.

The comparison module 152 can be configured to determine whether the features 118, 118′ of the sketches 116b, 116j that define the common interface CC are point continuous (C0), tangent continuous (C1) and/or curvature continuous (C2), and apply constraints to the resultant sketch 116k in response to the determining that the features 118, 118′ are continuous. For example, the comparison module 152 can be configured to query end points of the respective features 118, 118′ to determine whether the features 118, 118′ share the same physical space. The comparison module 152 can be configured to check the splines that establish a control volume for tangent continuity, and can be configured to check the slope adjacent to the common point of curves, lines or arcs.

Constraints of the resultant feature can be based on constraints of the respective features 118, 118′ along the common interface CC. The common interface CC can be defined such that geometry corresponding to the constraints of one or more features 118 of sketch 116b overlaps with geometry corresponding to the constraints of one or more features 118′ of sketch 116j along the common interface(s) CC.

The constraints of features 118, 118′ along the common interface CC can be combined to generate a common resultant feature. For example, constraints of geometric feature 118b and constraints of geometric feature 118b′ define respective end points along the common interface CC₁, as shown in FIG. 2C. Geometric feature 118b defines end points at points P₂ and P₃. Geometric feature 118b defines end points at points P₃ and P₈. A length and direction of the resultant geometric feature 118bb (FIG. 4) can be set according to a length and direction of the portion of the geometric feature 118b′ that does not overlap with the geometric feature 118b (i.e., between points P₂ and P₈).

In embodiments, the common interface CC is defined such that geometry corresponding to constraints of one or more features 118 of sketch 116b are identical to geometry corresponding to constraints of one or more features 118′ of sketch 116j along the respective common interface CC. For example, geometric features 118, 118′ of sketches 116b, 116j are defined along common interface CC₃. In embodiments, the resultant feature excludes at least one constraint defining the common interface CC. In the resultant sketch 116k (FIG. 4), for example, the geometric features 118, 118′ and the respective constraints along the common interface CC₃ are eliminated in the component design 114. Geometric features 118, 118′ of the sketches 116b, 116j along the respective common interfaces CC that are removed from the component design 114 are shown in dashed line in FIG. 4 for illustrative purposes. Removal or elimination of features 118, 118′ can reduce a total number of features of the component design 114 that are stored and loaded in the multi-user CAx environment 112, thereby reducing the demand for computational resources and improving efficiency of the CAx package 140.

Referring back to FIG. 3, the CAx package 140 can include a synchronization module 150 that interfaces or otherwise communicates with the data module 146. The synchronization module 150 can be configured to control or otherwise coordinate access to each database 109, component design 114, feature 116, feature type and/or part file, for example.

In embodiments, the synchronization module 150 is configured to cause features 116, 118 of the sketch 116b and features 116′, 118′ of the sketch 116j to merge into a resultant sketch 116k of the component design 114 in response to determining that a spatial boundary BR of the sketch 116b and a spatial boundary BR of the sketch 116j share a common interface CC. The synchronization module 150 can be configured to cause at least some features 116, 116′, 118, 118′ of the sketches 116b, 116j along the common interface CC to be eliminated in the database(s) 109 in response to determining that the at least some features 116, 116′, 118, 118′ extend along the common interface CC. The functionality of merging and/or eliminating the features can be provided utilizing any of the techniques disclosed herein.

In embodiments, the data module 146 and/or comparison module 152 provide the functionality of the synchronization module 150. The host computer 102 executing a host multi-user CAx environment 112c can provide the synchronization module 150 as one or more software services. A memory storage device of the host computer 102 can be configured to store the database(s) 109 accessible by the multi-user CAx environments 112, including CAx environments 112a, 112b, 112c. In another embodiment, each of the client computers 104 provided with one of the CAx environments 112a, 112b is operable to execute an instance of a synchronization module 150. In an embodiment, a single computing platform such as the host computer 102 or one of the client computers 104 is configured to execute the data module 146 and the synchronization module 150.

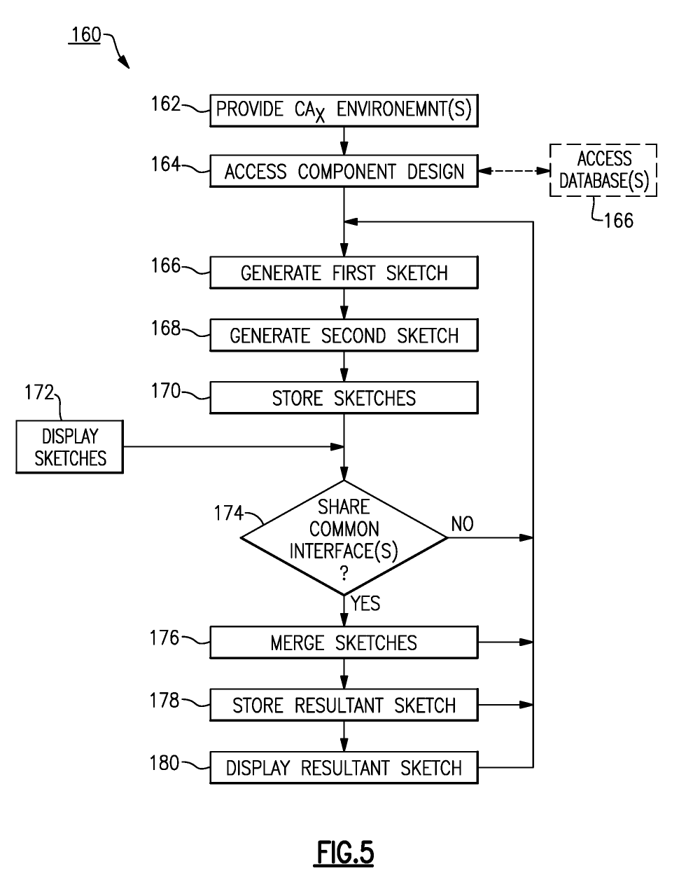

FIG. 5 illustrates a process or algorithm 160 for merging data corresponding to a component design, utilizing any of the techniques described in this disclosure and the CAx package 140 shown in FIG. 3, according to the process flow of FIG. 5. The algorithm 160 is executed within a CAx environment, such as one of the CAx environments 112a, 112b, 112c shown in FIGS. 2A-2B and FIG. 3. Although algorithm 160 is discussed primarily respect to sketches, the teachings herein can apply to combining or merging of other features of a component design including any of the features disclosed herein.

One or more multi-user CAx environments are provided at block 162. The component design is accessed by the CAx environment(s) at block 164. In embodiments, the algorithm 160 accesses the component design from one or more databases at block 166.

A first sketch of the component design is generated by a first multi-user CAx environment at block 166. A second sketch of the component design is generated by the first CAx environment, or by a second multi-user CAx environment at block 168. Generating the sketches at blocks 166, 168 can include creating or modifying features of the component design. Blocks 166, 168 can includes accessing the first and/or second sketches from the database by the first and/or second multi-user CAx environments.

At block 174, the algorithm 160 determines whether a spatial boundary of the first sketch and a spatial boundary of the second sketch share at least one common interface. Block 174 can include determining that geometry corresponding to constraints of the first sketch that define the common interface is identical to, or overlaps with, geometry corresponding to constraints of the second sketch along the common interface.

At block 176, the algorithm 160 causes aspects of the first sketch and the second sketch to merge into a resultant sketch of the component design in response to determining that the spatial boundaries of the first and second sketches share common interface(s), such as one of the common interfaces CC₁-CC₄ of the sketches 116b, 116k of FIG. 2C and the resultant sketch 116k of FIG. 4. Block 176 can include causing at least some of the geometric features of the respective sketches defined along the common interface(s) to be eliminated in the component design, including a version of the component design stored in the database or a local copy of the component design, for example.

Block 176 can include causing geometry of the resultant sketch to be at least one of point continuous, tangent continuous and curvature continuous relative to end points of the respective geometric features along the common interface. Constraints of the resultant sketch can be defined by constraints of the first and/or second sketches. The resultant sketch can exclude the constraints of the features along the common interface, and the resultant sketch can include one or more constraints that are based on a comparison of the constraints of the first and second sketches. A time stamp is associated with each feature in the component design, which can be associated with a part tree that has every feature. Block 176 can include deleting the duplicate sketches or feature(s) that are merged, or indicating that the duplicate sketches or feature(s) are sub-feature(s) of the resultant sketch or feature that can enable a user to later edit that specific section of data. Blocks 174, 176 can be executed using any of the techniques disclosed herein.

In embodiments, at least one of the sketches is stored in the database at block 170, which can occur prior to causing the first and second sketches to merge at block 176. In embodiments, the component design is displayed in the first and/or second multi-user CAx environments according to the first and/or second sketches at block 172, which can occur prior to causing the first sketch and the second sketch to merge at block 176.

At block 178, the resultant sketch can be stored in the database or another location such as a local copy of the component design. Block 178 can include storing the resultant sketch in the database or local copy such that the first and second sketches are replaced with the resultant sketch.

At block 180, the component design can be displayed in the first and/or second multi-user CAx environment according to the resultant sketch. In embodiments, block 180 includes displaying the component design according to the resultant sketch, but not according to the first or second sketches, which can occur subsequent to block 176.

The algorithm 160 can programmed in the CAx software directly, provided as one or more software plug-ins adapted to work with the native CAx software, or provided in a standalone program to interface with a CAx package to provide the desired solution. While the CAx package 140 and the algorithm 160 are described above in the context of a multi-user CAx environment executed on at least one host computer 102 or client computer 104, it should be understood that other CAx tools and architectures may benefit from the teachings of this disclosure. It should also be understood that the host computer 102, client computer 104 or other computing device running the multi-user CAx environment 112 can be programmed with multiple additional tools, and the various features and tools included can be configured to interoperate with each other according to known principles.

The teachings herein, including the CAx package 140 and the algorithm 160, can result in a reduction of time to model by allowing users to create multiple features but merge the final result such that the CAx system recognizes continuity of the geometry of the merged features, regardless of the number of features or sketches in a feature tree of the component design. Points, curves, edges, faces and bodies from multiple features can be merged or otherwise combined into a single entity to create boundary geometry corresponding to adjacent features of the component design.

Although the discussed embodiments illustrate a specific component, examples or embodiments of this disclosure are not limited to those particular combinations. One of skill in the art having the benefit of this disclosure will recognize that it is possible to use some of the components or features from one of the examples in combination with features or components from another one of the examples. Furthermore, various embodiments may include one or more examples within them, while other embodiments may include a different subset of examples. In addition, it will be understood that in various embodiments, a module may be a single module, or in some embodiments, the function of a single module may incorporate the features of multiple modules.

Furthermore, the foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A system for collaborating on a component, comprising:
a computing device including a processor and a memory storage device, the processor being configured to execute a first multi-user computer-aided technologies (CAx) environment including a data module and a comparison module;
wherein the data module is configured to access at least one database corresponding to a component design, the component design including a plurality of features each corresponding to a group of feature types, and each of the plurality of features establishing a respective spatial boundary; and
wherein the comparison module is configured to cause a first feature and a second feature of the plurality of features to merge into a resultant feature of the component design in response to determining that the spatial boundary of the first feature and the spatial boundary of the second feature share a common interface.

2. The system as recited in claim 1, wherein the first feature is a first sketch, and the second feature is a second, different sketch.

3. The system as recited in claim 2, wherein the first sketch includes a first set of features, and the second sketch includes a second, different set of features.

4. The system as recited in claim 3, wherein the first set of features includes a first geometric feature, the second set of features includes a second geometric feature, and the first geometric feature and the second geometric feature are defined along the common interface.

5. The system as recited in claim 4, wherein the first sketch is associated with the first multi-user CAx environment, and the second sketch is associated with a second multi-user CAx environment.

6. The system as recited in claim 1, wherein the comparison module causes the data module to store data corresponding to the component design in the at least one database such that first and second features are replaced with the resultant feature.

7. The system as recited in claim 1, wherein constraints of the resultant feature are based on constraints of the first feature and constraints of the second feature.

8. The system as recited in claim 7, wherein the resultant feature excludes at least one constraint defining the common interface.

9. The system as recited in claim 7, wherein the constraints of the first feature and the constraints of the second feature define respective end points along the common interface.

10. The system as recited in claim 9, wherein geometry of the resultant feature is at least one of point continuous, tangent continuous and curvature continuous relative to at least one of the respective end points.

11. The system as recited in claim 7, wherein the common interface is defined such that geometry corresponding to the constraints of the first feature overlaps with geometry corresponding to the constraints of the second feature along the common interface.

12. The system as recited in claim 11, wherein the common interface is defined such that geometry corresponding to the constraints of the first feature is identical to geometry corresponding to the constraints of the second feature along the common interface.

13. A system for collaborating on a component, comprising:
a first client multi-user computer-aided technologies (CAx) environment and a second client multi-user CAx environment each including a data module and a display module, the data module configured to access at least one database corresponding to a component design, the component design including a plurality of features each corresponding to a group of feature types, and the display module configured to display data corresponding to the component design during a multi-user CAx session established between the first client multi-user CAx environment and the second client multi-user CAx environment,
a host server including a processor and a memory storage device, the processor being configured to execute a host multi-user CAx environment having a synchronization module, and the memory storage device being configured to store the at least one database accessible by the host multi-user CAx environment;
wherein the plurality of features includes a first sketch and a second sketch, the first sketch associated with the first client multi-user CAx environment, the second sketch associated with the second client multi-user CAx environment, and each of the first and second sketches establishing a respective spatial boundary; and
wherein the synchronization module is configured to cause features of the first sketch and features of the second sketch to merge into a resultant sketch of the component design in response to determining that the spatial boundary of the first sketch and the spatial boundary of the second sketch share a common interface.

14. The system as recited in claim 13, wherein the synchronization module is configured to cause at least some features of the first and second sketches along the common interface to be eliminated in the at least one database in response to determining that the at least some features extend along the common interface.

15. A method for collaborating on a component, comprising the steps of:
generating a first sketch of a component design by a first multi-user computer-aided technologies (CAx) environment;
generating a second sketch of the component design by a second multi-user CAx environment;
wherein the component design includes a plurality of features corresponds to a group of feature types defined by a multi-user CAx command set executable by the first multi-user CAx environment and the second multi-user CAx environment, the plurality of features including a first set of geometric features associated with the first multi-user CAx environment and a second set of geometric features associated with the second multi-user CAx environment, and each of the first and second sketches establishes a respective spatial boundary; and
causing the first sketch and the second sketch to merge into a resultant sketch of the component design in response to determining that the spatial boundary of the first sketch and the spatial boundary of the second sketch share a common interface.

16. The method as recited in claim 15, wherein the step of determining that the spatial boundary of the first sketch and the spatial boundary of the second sketch share the common interface includes determining that geometry corresponding to constraints of the first sketch that define the common interface overlaps with geometry corresponding to constraints of the second sketch along the common interface.

17. The method as recited in claim 15, further comprising:
storing at least one of the first sketch and the second sketch in a database corresponding to the component design prior to the step of causing the first sketch and the second sketch to merge; and
storing the resultant sketch in the database.

18. The method as recited in claim 17, wherein:
geometric features of the first and second sketches are defined along the common interface; and
wherein the step of causing the first sketch and the second sketch to merge includes causing at least some of the geometric features to be eliminated in the database.

19. The method as recited in claim 18, wherein the step of causing the first sketch and the second sketch to merge includes causing geometry of the resultant sketch to be at least one of point continuous, tangent continuous and curvature continuous relative to an end point of at least one of the geometric features along the common interface.

20. The method as recited in claim 19, further comprising:
accessing the first sketch and the second sketch from the database by the first multi-user CAx environment;
displaying the component design in the first multi-user CAx environment according to the first sketch and the second sketch prior to the step of causing the first sketch and the second sketch to merge; and
displaying the component design in the first multi-user CAx environment according to the resultant sketch, but not according to the first sketch and the second sketch, subsequent to the step of causing the first sketch and the second sketch to merge.
